(19) United States
(12) Patent Application Publication
(10) Pub. No.: US 2013/0137009 A1
(43) Pub. Date: May 30, 2013

(54) ELECTRODE CATALYST FOR FUEL CELL, METHOD OF PREPARING THE SAME, AND MEMBRANE ELECTRODE ASSEMBLY AND FUEL CELL INCLUDING ELECTRODE CATALYST

(71) Applicants: Samsung Electronics Co., Ltd., Suwon-si (KR); Samsung SDI Co., Ltd., Yongin-si (KR)

(72) Inventors: Seon-ah JIN, Pocheon-si (KR); Chan-ho PAK, Seoul (KR); Dae-jong YOO, Seoul (KR); Kang-hee LEE, Suwon-si (KR)

(73) Assignees: SAMSUNG SDI CO., LTD., Yongin-si (KR); SAMSUNG ELECTRONICS CO., LTD., Suwon-si (KR)

(21) Appl. No.: 13/688,426

(22) Filed: Nov. 29, 2012

(30) Foreign Application Priority Data
Nov. 29, 2011 (KR) 10-2011-0126278
Nov. 2, 2012 (KR) 10-2012-0123746

(51) Int. Cl. H01M 4/92; H01M 8/10

(52) U.S. Cl. CPC H01M 4/926; H01M 8/1004
USPC 429/482; 502/325; 502/185; 502/101; 502/313; 502/326; 502/331; 502/339

(57) ABSTRACT

An electrode catalyst for a fuel cell which including alloy particles including a Group 8 metal and a Group 9 metal.

This application claims priority to and the benefit of Korean Patent Application No. 10-2011-0126278, filed on Nov. 29, 2011, and Korean Patent Application No. 10-2012-0123746, filed on Nov. 2, 2012, and all the benefits accruing therefrom under 35 U.S.C. §119, the contents of which are incorporated herein in their entirety by reference.

### BACKGROUND

1. Field

The present disclosure relates to an electrode catalyst for a fuel cell, methods of preparing the same, a membrane electrode assembly including the electrode catalyst, and a fuel cell including the electrode catalyst.

2. Description of the Related Art

Fuel cells are power generation systems which directly convert chemical energy obtained from a reaction between hydrogen and oxygen into electrical energy. Unlike batteries, fuel cells can continuously generate electricity as long as hydrogen and oxygen are supplied to the fuel cells. In addition, fuel cells can directly generate electricity, unlike conventional power generation methods which are limited by Carnot efficiency, and thus fuel cells may have about twice the efficiency of an internal combustion engine.

Fuel cells may be classified as a polymer electrolyte membrane fuel cell (“PEMFC”), a direct methanol fuel cell (“DMFC”), a phosphoric acid fuel cell (“PAFC”), a molten carbonate fuel cell (“MCFC”), and a solid oxide fuel cell (“SOFC”), according to the type of electrolyte and fuel used.

The PEMFC and the DMFC generally include a membrane electrode assembly (“MEA”) including an anode, a cathode, and a polymer electrolyte membrane disposed between the anode and the cathode. In a fuel cell, the anode includes a catalyst layer for facilitating oxidation of a fuel and the cathode includes a catalyst layer for facilitating reduction of an oxidant.

In general, a catalyst including or consisting of platinum (Pt) as an active element is widely used as a constituent of an anode and a cathode. However, Pt is an expensive precious metal and as the demand for Pt for use in the electrode catalyst increase in order to mass-produce fuel cells for the commercial market, the cost of Pt is expected to also increase. Thus it is desirable to develop compositions and methods that will decrease the manufacturing costs of fuel cells.

Therefore, there is a need to develop an electrode catalyst which includes a smaller amount of Pt used therein which can also provide high cell performance.

### SUMMARY

Provided is an electrode catalyst for a fuel cell which provides improved catalytic activity and improved life.

Provided are methods of preparing the electrode catalyst.

Provided is a membrane electrode assembly including the electrode catalyst.

Provided is a fuel cell including the membrane electrode assembly.

Additional aspects will be set forth in part in the description which follows and, in part, will be apparent from the description.

According to an aspect, an electrode catalyst for a fuel cell includes alloy particles including an alloy of a Group 8 metal and a Group 9 metal.

The Group 8 metal may include at least one of iron (Fe), ruthenium (Ru), and osmium (Os).

The Group 9 metal may include at least one of cobalt (Co), rhodium (Rh), and iridium (Ir).

An amount of the Group 8 metal may be in a range of about 8 atomic percent (at %) to about 92 at %, based on 100 at % of the alloy particles.

An amount of the Group 9 metal may be in a range of about 8 at % to about 90 at %, based on 100 at % of the alloy particles.

The alloy particles may have a core-shell structure. In the core-shell structure, i) the core may include the Group 8 metal, but does not include the Group 9 metal; and the shell may include the alloy of the Group 8 metal and the Group 9 metal; or ii) the core may include the alloy of the Group 8 metal and the Group 9 metal; and the shell may include the Group 9 metal, but does not comprise the Group 8 metal.

The alloy particles may have a core-interlayer-shell structure in which the interlayer is between the core and the shell. In the core-interlayer-shell structure, the core may include the Group 8 metal, but does not include the Group 9 metal; the interlayer may include the alloy of the Group 8 metal and the Group 9 metal; and the shell may include the Group 9 metal, but does not include the Group 8 metal.

The Group 8 metal may be ruthenium and the Group 9 metal may be iridium.

The electrode catalyst may further include a carbonaceous support, wherein the alloy particles are supported on the carbonaceous support.

According to another aspect of the present invention, an electrode catalyst for a fuel cell includes catalyst particles comprising a Group 8 metal and a Group 9 metal. The catalyst particles may have a core-shell structure. In the core-shell structure, the core may include the Group 8 metal, but does not include the Group 9 metal; and the shell may include the Group 9 metal, but does not include the Group 8 metal.

According to another aspect, a method of preparing an electrode catalyst for a fuel cell includes providing a mixture including a Group 8 metal precursor and a Group 9 metal precursor; and reducing the Group 8 metal precursor and the Group 9 metal precursor in the mixture to prepare the electrode catalyst for a fuel cell, wherein the electrode catalyst includes alloy particles including an alloy of a Group 8 metal and a Group 9 metal.

The mixture may further include a carbonaceous support, and the electrode catalyst may further include the carbonaceous support, wherein the alloy particles are supported on the carbonaceous support.

According to another aspect, a membrane electrode assembly for a fuel cell includes a cathode; an anode facing the cathode; and an electrolyte membrane interposed between the cathode and the anode, wherein at least one of the cathode and the anode includes the electrode catalyst described above.

In an embodiment, the anode may include the electrode catalyst.

According to another aspect, a fuel cell includes the membrane electrode assembly described above. The anode may include the electrode catalyst.

Also disclosed is electrode catalyst including a carbonaceous support; and alloy particles represented by Formula 1 disposed on the carbonaceous support

IrₓRu_{y} Formula 1

wherein x and y are each independently about 1 to about 10.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view schematically illustrating an embodiment of a catalyst;

FIG. 2 is an exploded perspective view of an embodiment of a fuel cell;

FIG. 3 is a cross-sectional view of an embodiment of a membrane electrode assembly (“MEA”) of the fuel cell of FIG. 1;

FIG. 4 is a graph of counts versus scattering angle (degrees 2θ) which illustrates X-ray diffraction (“XRD”) results of the electrode catalysts prepared according to Synthesis Examples 3 and Comparative Synthesis Example 2;

FIG. 5 is a graph of counts versus scattering angle (degrees 2θ) which illustrates XRD results of the electrode catalysts prepared according to Comparative Synthesis Example 1, Synthesis Example 5, Synthesis Example 1, Synthesis Example 2, Synthesis Example 4, and Comparative Synthesis Example 2;

FIG. 6 is a graph of Fourier Transform Intensity (arbitrary units) versus length (angstroms, Å) showing the results of Fourier transform analysis of extended X-ray absorption fine structure (“EXAFS”) analysis of Synthesis Examples 2 and 3, and Comparative Synthesis Examples 1 and 2, respectively;

FIG. 7 is a graph of hydrogen oxidation reaction (“HOR”) activity, (percent (%) versus PtRu/C) showing the results of evaluation of hydrogen oxidation reaction (“HOR”) activity by half cell measurement using the electrode catalysts prepared according to Synthesis Examples 1 to 4, Comparative Synthesis Examples 1 and 2, and a commercial PtRu/C catalyst, respectively; and

FIG. 8 is a graph of voltage (volts, V) versus current density (amperes per square centimeter, A/cm²) of unit cells manufactured according to Example 1 and Comparative Examples 1 to 3.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “or” means “and/or”, and the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

According to an embodiment, an electrode catalyst for a fuel cell (hereinafter, referred to as the “electrode catalyst”) includes alloy particles including an alloy of a Group 8 metal (wherein “Group” refers to a Group of the Periodic Table according to the IUPAC Group 1-18 numbering system) and a Group 9 metal. The “alloy particle” in the specification, may be referred to as a “catalyst particle”.

In a unit lattice of the “an alloy of a Group 8 metal and a Group 9 metal” Group 8 metal atoms and the Group 9 metal atoms co-exist. Thus, the “alloy particles including an alloy of a Group 8 metal and a Group 9 metal” are completely different from a mixture of Group 8 metal particles and Group 9 metal particles. In the mixture of Group 8 metal particles and Group 9 metal particles, Group 8 metal atoms or Group 9 metal atoms exist in a single unit lattice.

The alloy particles may be amorphous (formless) and the alloy particles may be independently separated from one another and disposed, e.g., supported or dispersed on, a selected support, and thus the alloy particles are different from a layer comprising the Group 8 metal and the Group 9 metal. The alloy particles including the alloy of a Group 8 metal and a Group 9 metal, which in an embodiment are amorphous (formless) particles, have a far larger specific surface area that contacts a gas and/or a liquid (e.g., H₂ or CH₃OH) which may be subjected to an electrochemical reaction than that of the layer formed of the Group 8 metal and the Group 9 metal, and thus may suitable for use as a catalyst, e.g., an electrode catalyst for a fuel cell. For example, the alloy particles may be disposed, e.g., supported on, a carbonaceous support, which will be further described below, and dispersed thereon.

The Group 8 metal may include at least one of iron (Fe), ruthenium (Ru), and osmium (Os). For example, the Group 8 metal may be Ru, but is not limited thereto.

The Group 9 metal may include at least one of cobalt (Co), rhodium (Rh), and iridium (Ir). For example, the Group 9 metal may be Ir, but is not limited thereto.

The amount of the Group 8 metal may be in the range of about 8 atomic percent (at %) to about 92 at %, for example, in the range of about 20 at % to about 90 at %, specifically about 40 at % to about 90 at %, based on 100 at % of the alloy particles. The amount of the Group 9 metal may be in the range of about 8 at % to about 90 at %, for example, in the range of about 10 at % to about 80 at %, specifically about 10 at % to about 50%, based on 100 at % of the alloy particles. When the amounts of the Group 8 metal and the Group 9 metal are within the ranges described above, an electrode including the electrode catalyst may have excellent hydrogen oxidation performance.

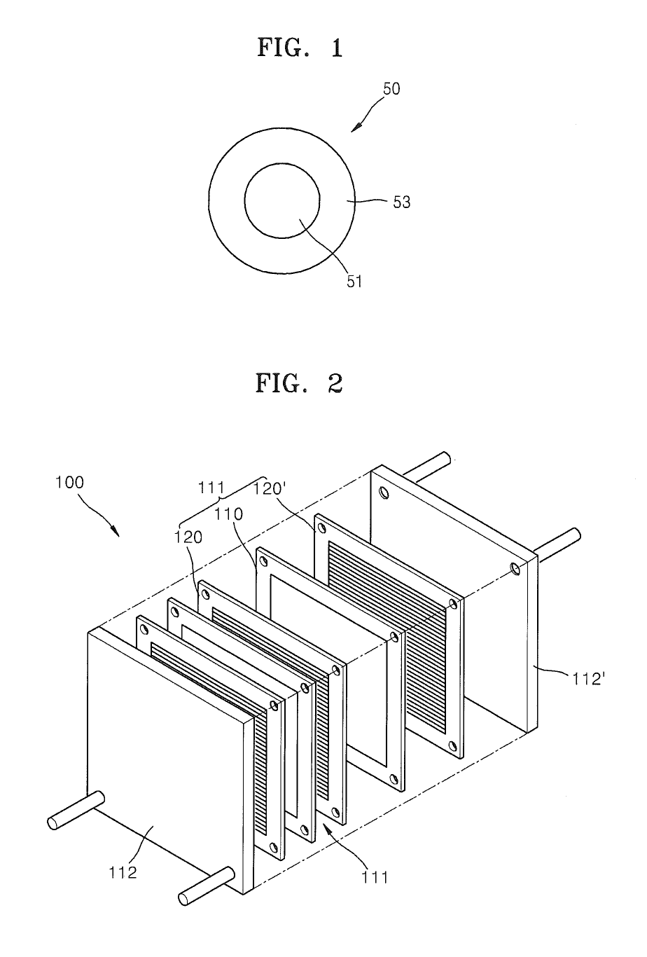

The alloy particles may have a core-shell structure, an embodiment of which is disclosed in FIG. 1. FIG. 1 is a cross sectional view schematically illustrating an embodiment of the alloy particles 50, the alloy particles 50 including a shell 53 disposed on a core 51, i.e., that covers over all or part of the surface of a core 51 described above. The shell 53 may be a continuous layer that covers over all of the surface of the core 51, or may be a non-continuous layer that covers a portion of the surface of the core 51.

In one embodiment, the core 51 described above may include the Group 8 metal, but does not include the Group 9 metal; and the shell may include an alloy the Group 8 metal and the Group 9 metal. For example, the core-shell structure, the core 51 described above may consist of the Group 8 metal; and the shell may consist of an alloy of the Group 8 metal and Group 9 metal.

In other embodiment, the alloy particles may have a “Ru core”-“IrRu alloy shell” structure.

In other embodiment, the core 51 described above may include the alloy of the Group 8 metal and the Group 9 metal; and the shell may include the Group 9 metal, but does not include the Group 8 metal. For example, the core-shell structure, the core 51 described above may consist of the alloy of the Group 8 metal and the Group 9 metal; and the shell may consist of the Group 9 metal.

It is to be understood that even where the alloy particles, the core and the shell “consist of” a metal or alloy thereof, trace contaminants (e.g., less than 0.1 weight percent, or less than 500 parts per million of each contaminant) may be present, trace contaminants being elements that are not feasibly removable using current commercially available technologies.

In other embodiment, the alloy particles may have a “IrRu alloy core”-“Ir shell” structure.

An interlayer, which is not described in FIG. 1, may be further disposed between the core 51 and shell 53. Therefore, in other embodiment, the alloy particles may have a core-interlay-shell structure in which the interlayer is between the core and the shell.

In the core-interlayer-shell structure, the core may include the Group 8 metal, but does not include the Group 9 metal; the interlayer may include the alloy of the Group 8 metal and the Group 9 metal; and the shell may include the Group 9 metal, but does not include the Group 8 metal. For example, in the core-interlayer-shell structure, the core may consist of the Group 8 metal; the interlayer may consist of an alloy of the Group 8 metal and the Group 9 metal; and the shell may consist of the Group 9 metal.

In other embodiment, the alloy particles may have a “Ru core”-“IrRu alloy interlayer”-“Ir shell”.

The structure of the alloy particle may be confirmed by extended X-ray absorption fine structure (EXAFS) analysis, which will be described below.

In an embodiment, the Group 8 metal may be Ru and the Group 9 metal may be Ir, but the Group 8 and 9 metals are not limited thereto.

The alloy particles of the electrode catalyst may consist of the Group 8 metal and the Group 9 metal. The alloy particles of the electrode catalyst may consist of Ru and Ir. For example, the alloy particles may be represented by Formula 1 below, but is not limited thereto:

IrₓRu_{y} Formula 1

wherein x and y are each independently a real number in the range of about 1 to about 10. In this regard, x/y indicates an atomic ratio of Ir to Ru (Ir/Ru) of the alloy particles.

For example, in Formula 1, x and y satisfy the conditions: 1≦x≦8 and 1≦y≦9.7, but are not limited thereto.

As another example, in Formula 1, x and y satisfy the conditions: 1≦x≦4 and 1≦y≦9.5, but are not limited thereto.

As another example, in Formula 1, x and y satisfy the conditions: 1≦x≦8 and 1≦y≦9, but are not limited to.

As another example, in Formula 1, x and y satisfy the conditions: 1≦x≦1.2 and 1≦y≦9, but are not limited thereto.

As another example, in Formula 1, x and y satisfy the conditions: 1≦x≦5 and 1≦y≦2, but are not limited thereto.

It is to be understood that even where the alloy particles, the core, and the shell “consist of a metal or alloy thereof, trace contaminants (e.g., less than 0.1 weight percent, or less than 500 parts per million of each contaminant) may be present that are not feasibly removable using current commercially available technologies.

The alloy particles may further include an additional metal comprising at least one of nickel (Ni), palladium (Pd), platinum (Pt), Co, Fe, copper (Cu), tungsten (W), vanadium (V), niobium (Nb), molybdenum (Mo), and hafnium (Hf). The additional metal may be in the form of an alloy of the Group 8 metal and the Group 9 metal. A content of the additional metal may be about 0.1 at % to about 50 at %, specifically about 1 at % to about 40 at %, more specifically about 2 at % to about 30 at %, based on a total content of the alloy particles. In an embodiment, a content of the additional metals may, in total, be about 0.1 at % to about 10 at %, specifically about 0.2 at % to about 8 at %, more specifically about 0.5 at % to about 5 at %, based on a total content of the alloy particles.

In an embodiment in which the electrode catalyst further, in addition to the alloy particles described above, includes the at least one of Ni, Pd, Pt, Co, Fe, Cu, W, V, Nb, Mo, and Hf, these materials may be included in a coating layer which is disposed, e.g., formed on a portion of surfaces of the alloy particles, or in the form of particles which are physically mixed with the alloy particles.

An average diameter of the alloy particles may be in the range of about 0.1 nanometers (nm) to about 100 nm, specifically about 0.5 nm to about 30 nm. When the average diameter of the alloy particles is within the range described above, an electrode including the electrode catalyst may have excellent hydrogen oxidation performance.

The electrode catalyst may further include a carbonaceous support. In this case, the alloy particles may be supported on the carbonaceous support.

The carbonaceous support may be selected from electrically conductive materials. For example, the carbonaceous support may comprise at least one of Ketjen black, carbon black, graphitic carbon, carbon nanotubes, carbon fiber, mesoporous carbon, or graphene, or the like, but is not limited thereto.

If the electrode catalyst further includes the carbonaceous support, the amount of the alloy particles may be in the range of about 10 parts by weight to about 80 parts by weight, for example, in the range of about 40 parts by weight to about 60 parts by weight, based on 100 parts by weight of the electrode catalyst including the carbonaceous support. If an amount of the alloy particles to the carbonaceous support is within the range described above, the electrode catalyst particles may have large specific surface area and a large amount of the electrode catalyst particles may be supported.

The electrochemical specific surface area of the electrode catalyst may be about 20 square meters per gram (m²/g) to about 500 m²/g, specifically about 30 m²/g to about 400 m²/g, more specifically about 40 m²/g to about 300 m²/g, based on a total weight of the Group 8 metal and the Group 9 metal.

A specific activity of the electrode catalyst may be about 50 to about 500 amperes per gram, based on a total weight of the Group 8 metal and the Group 9 metal.

A hydrogen oxidation activity of the electrode catalyst may be about 80% to about 140%, specifically about 100% to about 120%, of a hydrogen oxidation activity of a carbon supported PtRu catalyst.

According to another aspect of the present invention, an electrode catalyst for a fuel cell includes catalyst particles comprising a Group 8 metal and a Group 9 metal. The catalyst particles may be represented by Formula 1 above. The catalyst particles may have a core-shell structure. In the core-shell structure, the core may include the Group 8 metal, but does not include the Group 9 metal; and the shell may include the Group 9 metal, but does not include the Group 8 metal. For example, the catalyst particles may have a core-shell structure in which the core consists of the Group 8 metal and the shell consists of the Group 9 metal. As one example, the catalyst particles may have a “Ru core”-“Ir shell” structure. The catalyst particles may further include at least one of nickel (Ni), palladium (Pd), platinum (Pt), Co, Fe, copper (Cu), tungsten (W), vanadium (V), niobium (Nb), molybdenum (Mo), and hafnium (Hf). The electrode catalyst may further include a carbonaceous support described above.

A method of preparing the electrode catalyst for a fuel cell will now be described in further detail.

First, a mixture including a Group 8 metal precursor and a Group 9 metal precursor is provided. If the alloy particles of the electrode catalyst include two or more different Group 8 metals, two or more different Group 8 metal precursors may be used. As used herein the term “mixture” is inclusive of combinations, solutions, suspensions, dispersions, and the like.

The Group 8 metal precursor may include at least one compound of a chloride, a nitride, a cyanide, a sulfide, a bromide, a nitride, an acetate, a sulfate, an oxide, a hydroxide, or an alkoxide, each of which includes the Group 8 metal described above.

For example, if the Group 8 metal is ruthenium, the ruthenium precursor may be, but is not limited to, at least one of a ruthenium nitride, a ruthenium chloride, a ruthenium sulfide, a ruthenium acetate, a ruthenium acetylacetonate, a ruthenium cyanate, a ruthenium isopropyl oxide, or a ruthenium butoxide.

The Group 9 metal precursor may include at least one compound of a chloride, a nitride, a cyanide, a sulfide, a bromide, a nitride, an acetate, a sulfate, an oxide, a hydroxide, or an alkoxide, each of which includes the Group 9 metal described above.

For example, if the Group 9 metal is iridium, the iridium precursor may be, but is not limited to, at least one of an iridium nitride, an iridium chloride, an iridium sulfide, an iridium acetate, an iridium acetylacetonate, an iridium cyanate, an iridium isopropyl oxide, or an iridium butoxide.

The mixture may further include, in addition to the Group 8 metal precursor and the Group 9 metal precursor described above, at least one precursor of Ni, Pd, Pt, Co, Fe, Cu, W, V, Nb, Mo, or Hf (e.g., at least one compound of a chloride, a nitride, a cyanide, a sulfide, a bromide, a nitride, an acetate, a sulfate, an oxide, a hydroxide, or an alkoxide of at least one of Ni, Pd, Pt, Co, Fe, Cu, W, V, Nb, Mo, or Hf).

The mixture may further include a carbonaceous support. If the mixture further includes a carbonaceous support, an electrode catalyst including the carbonaceous support and the alloy particles supported on the carbonaceous support may be obtained.

The mixture may further include, in addition to the Group 8 metal precursor and the Group 9 metal precursor, a solvent that dissolves and/or suspends these precursors. Examples of the solvent include a polyol such as ethylene glycol, 1,2-propylene glycol, 1,3-butanediol, 1,4-butanediol, neopentyl glycol, diethylene glycol, 3-methyl-1,5-pentanediol, 1,6-hexanediol, trimethylol propane, or the like; a monol, such as methanol, ethanol, isopropyl alcohol (IPA), butanol, or the like; or water (H₂O). However, the solvent is not limited to the above examples, and any suitable solvent which dissolves and/or suspends the precursors may be used.

The mixture may further include a chelating agent (e.g., citric acid, or ethylene diamine tetraacetate (“EDTA”)) for simultaneously reducing the Group 8 metal precursor and the Group 9 metal precursor, a pH adjuster (e.g., NaOH), or the like.

Subsequently, the Group 8 metal precursor and the Group 9 metal precursor in the mixture are reduced to form an electrode catalyst with hydrogen oxidation activity which includes alloy particles including the Group 8 metal and the Group 9 metal. In this regard, if the mixture includes a carbonaceous support, an electrode catalyst including the alloy particles that are dispersed on the carbonaceous support may be obtained.

The reducing process of the precursors included in the mixture may be performed by adding a reducing agent to the mixture. Alternatively, the reducing process of the precursors included in the mixture may be performed by drying (e.g., drying under reduced pressure) the mixture to obtain a carbonaceous support-precursor composite in which the precursors are supported on the carbonaceous support and then heat treating (e.g., heat treating in an electrical furnace) the carbonaceous support-precursor composite in an inert or gas atmosphere (e.g., hydrogen atmosphere).

The reducing agent may be selected from materials that reduce the precursors included in the mixture. For example, the reducing agent may be hydrazine (NH₂NH₂), sodium borohydride (NaBH₄), formic acid, ascorbic acid, or the like, but is not limited thereto. The amount of the reducing agent may be in the range of about 1 mole to about 3 moles, based on 1 mole of the Group 8 metal precursor and the Group 9 metal precursor. If the amount of the reducing agent is within the range described above, a satisfactory reduction reaction may be induced.

The heat treatment of the carbonaceous support-precursor composite in an inert atmosphere may be performed at a temperature in the range of about 100° C. to about 500° C., for example, in the range of about 150° C. to about 450° C.; however, the heat treatment temperature is not limited thereto.

According to another embodiment, a membrane electrode assembly (“MEA”) for a fuel cell includes a cathode, an anode facing the cathode, and an electrolyte membrane interposed between the cathode and the anode, wherein at least one of the cathode and the anode includes the electrode catalyst for a fuel cell described above. For example, the electrode catalyst may be included in the anode of the MEA.

According to another embodiment, a fuel cell includes the MEA and separators disposed on opposite sides of the MEA. The MEA includes a cathode, an anode, and an electrolyte membrane disposed between the cathode and the anode, and at least one of the cathode and the anode includes the electrode catalyst described above. The electrode catalyst may be included in the anode of the fuel cell.

For example, the fuel cell may be a polymer electrolyte membrane fuel cell (“PEMFC”), a phosphoric acid fuel cell (“PAFC”), or a direct methanol fuel cell (“DMFC”).

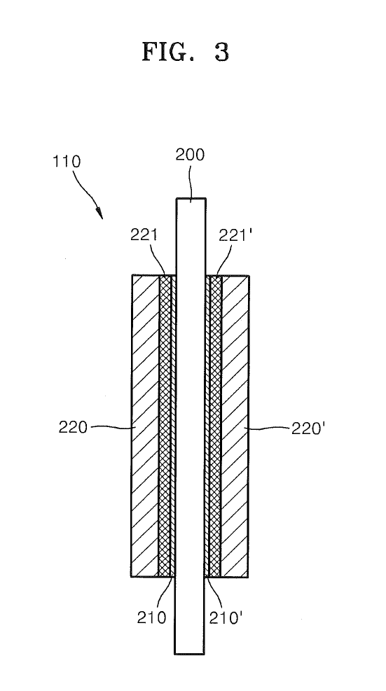

FIG. 2 is an exploded perspective view of an embodiment of a fuel cell 100, and FIG. 3 is a cross-sectional view of an embodiment of MEA of the fuel cell 100 of FIG. 2.

Referring to FIG. 2, the fuel cell 100 includes a unit cell 111 that is interposed between first and second end plates 112 and 112′. The unit cell 111 includes an MEA 110 and first and second bipolar plates 120 and 120′, respectively, disposed on opposite sides of the MEA 110 in a thickness direction of the MEA 110. The first and second bipolar plates 120 and 120′ may each comprise conductive metal or carbon and may each contact the MEA 110, so that the first and second bipolar plates 120 and 120′ function as a current collector and supply oxygen and a fuel, respectively, to cathode and anode catalyst layers of the MEA 110.

In the embodiment of FIG. 2, the fuel cell 100 includes two unit cells 111, but the number of unit cells is not limited thereto. For example, the number of the unit cells 111 may be tens to hundreds as desired. In an embodiment, the fuel cell comprises 2 to 1000 unit cells.

Referring to FIG. 3, the MEA 110 includes an electrolyte membrane 200; first and second catalyst layers 210 and 210′ that are disposed on opposite sides of the electrolyte membrane 200 in a thickness direction thereof, at least one of which includes the electrode catalyst disclosed herein; first and second primary gas diffusion layers 221 and 221′ that are respectively disposed on the first and second catalyst layers 210 and 210′; and first and second secondary gas diffusion layers 220 and 220′ that are respectively disposed on the first and second primary gas diffusion layers 221 and 221′.

The first and second catalyst layers 210 and 210′ may function as a fuel electrode and an oxygen electrode, respectively, each of which includes a catalyst and a binder, and may further include a material that increases an electrochemical surface area of the catalyst. A loading of the electrode catalyst on the first and/or the second catalyst layer may be about 0.01 mg/cm² to about 1 mg/cm², based on a total weight of the Group 8 metal and the Group 9 metal and a surface area of the catalyst layer.

The first and second primary gas diffusion layers 221 and 221′ and the first and second secondary gas diffusion layers 220 and 220′ may each include, for example, carbon sheet, carbon paper, or the like, and may diffuse oxygen and a fuel supplied through the first and second bipolar plates 120 and 120′ to an entire surface of the first and second catalyst layers 210 and 210′.

The fuel cell 100 including the MEA 110 operates at a temperature of about 100° C. to about 300° C. A fuel, for example, hydrogen is supplied to the first catalyst layer 210 through the first bipolar plate 120 and an oxidizing agent, for example, oxygen or air, is supplied to the second catalyst layer 210′ through the second bipolar plate 120′. Also, at the first catalyst layer 210, hydrogen is oxidized to generate a hydrogen ion (H⁺) and then the hydrogen ion (H⁺) conducts through the electrolyte membrane 200 and reaches the second catalyst layer 210′, and at the second catalyst layer 210′, the hydrogen ion (H⁺) electrochemically reacts with oxygen to generate water (H₂O) and electric energy. In an embodiment wherein the fuel is hydrogen, the hydrogen may be generated by reforming a hydrocarbon, or the fuel may be an alcohol. The oxygen supplied as an oxidizing agent may be supplied in the form of air.

An embodiment will now be described in further detail with reference to the following examples. These examples are for illustrative purpose only and are not intended to limit the scope of the disclosed embodiment.

### EXAMPLES

### Synthesis Example 1

### Synthesis of IrRu/C Catalyst

0.5 grams (g) of Ketjen Black (“KB”) as a carbonaceous support was added to a mixture including 0.785 g of iridium chloride as an iridium precursor, 0.443 g of ruthenium chloride as a ruthenium precursor, and distilled water, and the resulting mixture was then stirred. The stirred mixture was distilled under reduced pressure at 50° C. and dried, and the dried product was heat treated at 300° C. in a hydrogen atmosphere to reduce the iridium precursor and the ruthenium precursor that were supported on the carbonaceous support. As a result, IrRu/C was obtained as an electrode catalyst for a fuel cell.

### Synthesis Example 2

### Synthesis of IrRu₄/C Catalyst

IrRu₄/C was prepared as an electrode catalyst for a fuel cell in the same manner as in Synthesis Example 1, except that the iridium precursor was used in an amount of 0.393 g and the ruthenium precursor was used in an amount of 0.885 g.

### Synthesis Example 3

### Synthesis of IrRu₆/C Catalyst

IrRu₆/C was prepared as an electrode catalyst for a fuel cell in the same manner as in Synthesis Example 1, except that the iridium precursor was used in an amount of 0.293 g and the ruthenium precursor was used in an amount of 0.934 g.

### Synthesis Example 4

### Synthesis of IrRu₉/C Catalyst

IrRu₉/C was prepared as an electrode catalyst for a fuel cell in the same manner as in Synthesis Example 1, except that the iridium precursor was used in an amount of 0.213 g and the ruthenium precursor was used in an amount of 1.078 g.

### Synthesis Example 5

### Synthesis of Ir₄Ru/C Catalyst

Ir₄Ru/C was prepared as an electrode catalyst for a fuel cell in the same manner as in Synthesis Example 1, except that the iridium precursor was used in an amount of 1.077 g and the ruthenium precursor was used in an amount of 0.142 g.

### Comparative Synthesis Example 1

### Preparation of Ir/C Catalyst

An Ir/C catalyst was prepared in the same manner as in Synthesis Example 1, except that the iridium precursor was used in an amount of 1.219 g and the ruthenium precursor was not used.

### Comparative Synthesis Example 2

### Preparation of Ru/C Catalyst

A Ru/C catalyst was prepared in the same manner as in Synthesis Example 1, except that the iridium precursor was not used and the ruthenium precursor was used in an amount of 1.231 g.

TABLE 1

| | | Active particles | Atomic |
|---|---|---|---|
| | Composition | supported on | ratio of |
| | of catalyst | carbonaceous support | Ir to Ru |
| Synthesis | IrRu/C | Alloy particles of | 1:1 |
| Example 1 | | iridium and ruthenium | |
| Synthesis | IrRu₄/C | Alloy particles of | 1:4 |
| Example 2 | | iridium and ruthenium | |
| Synthesis | IrRu₆/C | Alloy particles of | 1:6 |
| Example 3 | | iridium and ruthenium | |
| Synthesis | IrRu₉/C | Alloy particles of | 1:9 |
| Example 4 | | iridium and ruthenium | |
| Synthesis | Ir₄Ru/C | Alloy particles of | 4:1 |
| Example 5 | | iridium and ruthenium | |
| Comparative | Ir/C | Iridium particles | — |
| Synthesis | | | |
| Example 1 | | | |
| Comparative | Ru/C | Ruthenium particles | — |
| Synthesis | | | |
| Example 2 | | | |

### Evaluation Example 1

### Inductively Coupled Plasma (ICP) Analysis

The catalysts prepared according to Synthesis Examples 1 to 5 and Comparative Synthesis Examples 1 and 2 were analyzed by inductively coupled plasma (“ICP”) elemental analysis (ICP-AES, ICPS-8100, SHIMADZU/RF source 27.12 MHz/sample uptake rate 0.8 milliliters per minute, mL/min), and the results are shown in Table 1 below.

TABLE 2

| | |
|---|---|
| Composition | Metal content (wt %) |

| | of catalyst | Iridium | Ruthenium |
|---|---|---|---|
| Synthesis | IrRu/C | 13.1 | 29.8 |
| Example 1 | | | |
| Synthesis | IrRu₄/C | 12.6 | 26.8 |
| Example 2 | | | |
| Synthesis | IrRu₆/C | 9.1 | 28.4 |
| Example 3 | | | |
| Synthesis | IrRu₉/C | 7.08 | 34.2 |
| Example 4 | | | |
| Synthesis | Ir₄Ru/C | 35.5 | 4.5 |
| Example 5 | | | |
| Comparative | Ir/C | 39.2 | — |
| Synthesis | | | |
| Example 1 | | | |
| Comparative | Ru/C | — | 40.5 |
| Synthesis | | | |
| Example 2 | | | |

From the results shown in Table 2, it was confirmed that the catalysts of Synthesis Examples 1 to 5 included both iridium and ruthenium.

### Evaluation Example 2

### X-Ray Diffraction (XRD) Analysis

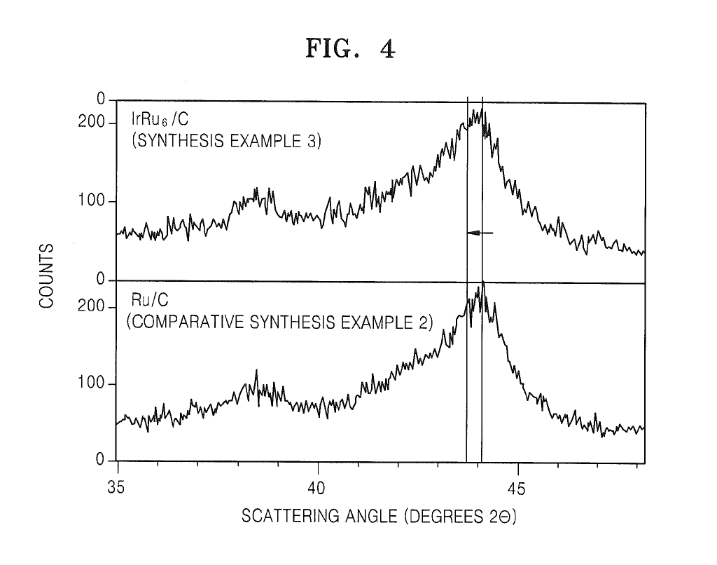

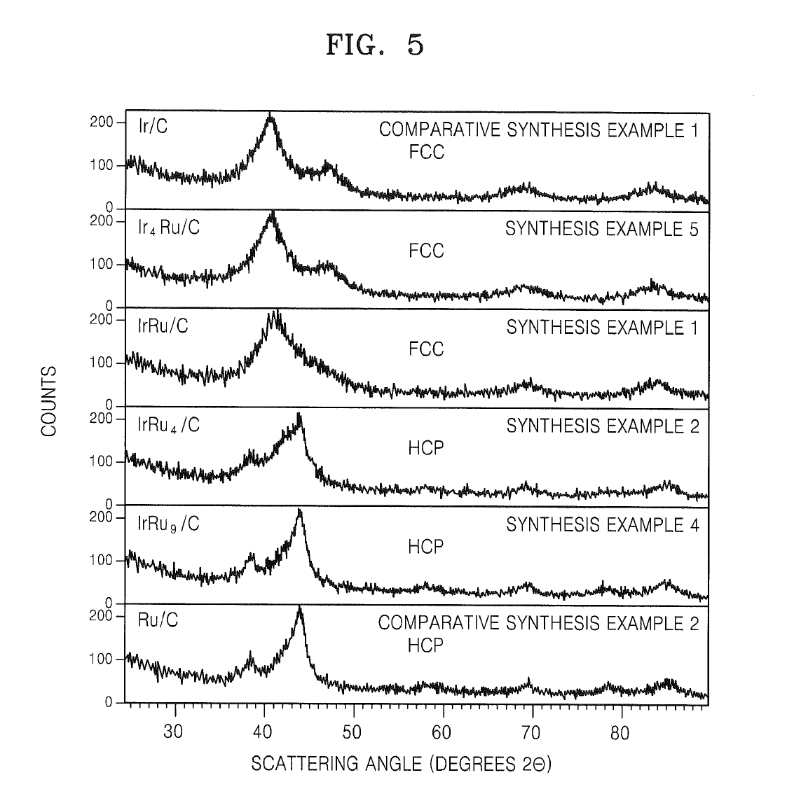

XRD analysis (MP-XRD, Xpert PRO, Philips/Power 3 kW) was performed on the catalysts of Synthesis Examples 1, 2, 4, and 5 and Comparative Synthesis Examples 1 and 2, and the results are shown in FIGS. 4 and 5. A lattice constant of each catalyst is shown in Table 3 below:

TABLE 3

| | | Crystal | Diffraction | Diffraction |
|---|---|---|---|---|
| | | structure | angle (2θ | angle (2θ |
| | Composition | of catalyst | of main peak | of main peak |
| | of catalyst | particles | of Ir) (111) | of Ru) (101) |
| Synthesis | IrRu/C | FCC¹ | 41.194 | — |
| Example 1 | | | | |
| Synthesis | IrRu₄/C | HCP² | — | 43.845 |
| Example 2 | | | | |
| Synthesis | IrRu₉/C | HCP | — | 43.977 |
| Example 4 | | | | |
| Synthesis | Ir₄Ru/C | FCC | 40.734 | |
| Example 5 | | | | |
| Comparative | Ir/C | FCC | 40.605 | — |
| Synthesis | | | | |
| Example 1 | | | | |
| Comparative | Ru/C | HCP | — | 44.037 |
| Synthesis | | | | |
| Example 2 | | | | |

¹Face Centered Cubic
²Hexagonal Closed-Packed

Referring to Table 3 and FIGS. 4 and 5, it is confirmed that each of the catalysts of Synthesis Examples 1, 2, 4, and 5 have a different crystal structure according to a ratio of elements (metals) included in each catalyst and includes alloy particles having a crystal structure of an element that is included therein in a large amount.

As a result of performing ICP analysis on an actual composition of the IrRu/C catalyst of Synthesis Example 1, the actual composition of the IrRu/C catalyst of Synthesis Example 1 was Ir_{1.2}Ru₁/C (refer to Table 2). As a result, an XRD pattern of the Ir_{0.5}Ru_{0.5}/C catalyst of Synthesis Example 1 was confirmed such that a main peak of Ir was dominantly observed.

Also, the main peak (at 2θ=41.194°) of the electrode catalyst of Synthesis Example 1 was shifted to a larger value than the main peak (at 2θ=40.605°) of the electrode catalyst of Comparative Synthesis Example 1. From this result, it was confirmed that the electrode catalyst of Synthesis Example 1 comprises alloy particles of iridium and ruthenium. In addition, the main peak (at 2θ=43.895°) of the electrode catalyst of Synthesis Example 2 and the main peak (at 2θ=43.977°) of the electrode catalyst of Synthesis Example 4 were shifted to a smaller value than the main peak (at) 2θ=44.037°) of the electrode catalyst of Comparative Synthesis Example 2. From this result, it was confirmed that the electrode catalysts of Synthesis Example 1 comprised alloy particles of iridium and ruthenium.

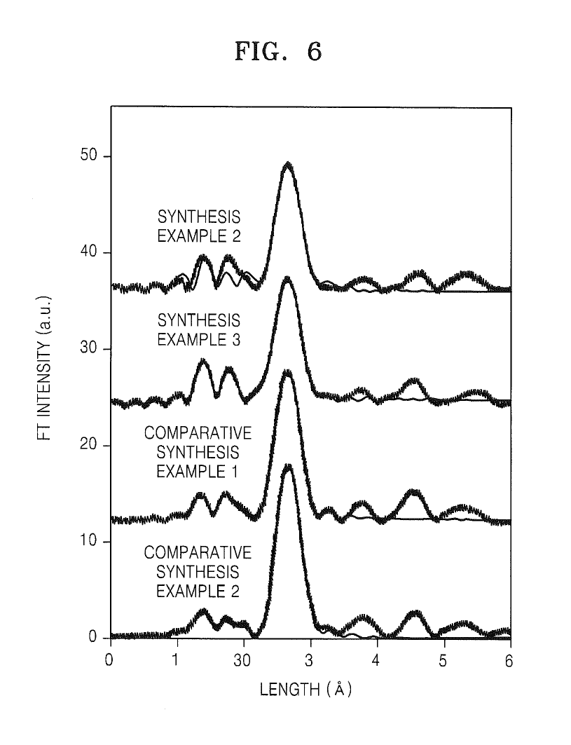

Referring to the catalysts of Synthesis Examples 2 to 5, and Comparative Synthesis Examples 1 and 2, EXAFS analysis was performed to evaluate a structure of the catalyst, and the results are shown in FIG. 6 and Table 4.

An EXAFS experiment was performed by analyzing the results measured using a Rigaku R-XAS apparatus at room temperature and atmospheric pressure, using the Artemis and Athena analysis software.

TABLE 4

| Absorption | Synthesis | Composition | Observed | R | | σ² |
|---|---|---|---|---|---|---|
| edge | No. | of catalyst | binding | (nm) | N | (pm²) |
| absorption | Comparative | Ir/C | Ir—C | 0.202 | 5.0 | 73 |
| edge of Ir | Synthesis | | Ir—Ir | 0.270 | 5.3 | 62 |
| LIII | Example 1 | | | | | |
| | Synthesis | Ir₄Ru/C | Ir—C | 0.196 | 2.0 | 0 |
| | Example 5 | | Ir—Ir | 0.263 | 9.2 | 108 |
| | | | Ir—Ru | 0.259 | 0.5 | 44 |
| | Synthesis | IrRu/C | Ir—C | 0.197 | 2.2 | 2 |
| | Example 1 | | Ir—Ir | 0.259 | 3.5 | 50 |
| | | | Ir—Ru | 0.261 | 1.0 | 22 |
| | Synthesis | IrRu₄/C | Ir—C | 0.196 | 2.1 | 0 |
| | Example 2 | | Ir—Ir | 0.255 | 3.8 | 57 |
| | | | Ir—Ru | 0.258 | 1.2 | 41 |
| | Synthesis | IrRu6/C | Ir—C | 0.197 | 2.9 | 0 |
| | Example 3 | | Ir—Ir | 0.260 | 2.1 | 38 |
| | | | Ir—Ru | 0.263 | 1.8 | 20 |
| | Synthesis | IrRu₉/C | Ir—C | 0.197 | 3.1 | 0 |
| | Example 4 | | Ir—Ir | 0.256 | 1.2 | 0 |
| | | | Ir—Ru | 0.260 | 0.8 | 0 |
| absorption | Comparative | Ru/C | Ru—Ru | 0.268 | 6.4 | 57 |
| edge of Ru | Synthesis | | | | | |
| K | Example 2 | | | | | |
| | Synthesis | IrRu₉/C | Ru—Ru | 0.267 | 3.1 | 19 |
| | Example 4 | | Ru—Ir | 0.265 | 1.3 | 11 |
| | Synthesis | IrRu₆/C | Ru—Ru | 0.266 | 2.2 | 2 |
| | Example 3 | | Ru—Ir | 0.264 | 1.4 | 0 |
| | Synthesis | IrRu₄/C | Ru—Ru | 0.266 | 3.5 | 39 |
| | Example 2 | | Ru—Ir | 0.262 | 2.7 | 54 |

In Table 4, R is a distance to a neighboring atom; N is the number of neighboring atoms; σ² is the disorder in the neighbor distance.

Referring to Table 4 and FIG. 6, as a result of quantitative analysis of the local structure for each absorption edge of the metals, the binding of Ir and Ru around Ir atoms and the simultaneous presence of Ru and Ir around Ru atoms was confirmed for the catalysts of Synthesis Examples 1 to 5. Thereby, it was confirmed that an alloy of Ir and Ru was formed within the catalysts of Synthesis Examples 1 to 5.

Also, by comparison of the N value (atom coordination number) of Ru—Ir binding from the absorption edge of Ru K in Table 4, it was confirmed that when the content of Ir is increased, Ir coordination around Ru is also increased (namely, Synthesis Example 4: 1.3/Synthesis Example 3: 1.4/Synthesis Example 2: 2.7). In comparison with the N value of Ru—Ru binding from the absorption edge of Ru K in Table 4, it was confirmed that the coordination numbers between Ru were maintained in a practical way without a significant increase (namely, Synthesis Example 4: 3.1/Synthesis Example 3: 2.2/Synthesis Example 4: 3.5). Also, the N value of Ir—C(O) binding from absorption edge of Ir L_{III} in Table 4 was confirmed to have a certain value, e.g., 2 to 5. Since the amount of Ir is relatively large on the outside of the catalyst particles of Synthesis Examples 1 to 5, Ir may be bound to a carbon (C) or oxygen on the support. Therefore, it was confirmed that the catalyst particles of Synthesis Examples 1 to 5 may have a “Ru core”-“IrRu alloy shell” structure; a “IrRu alloy core”-“Ir shell” structure; or a “Ru core”-“IrRu alloy interlayer”-“Ir shell” structure.

### Evaluation Example 4

### Half Cell Performance Evaluation

A Hydrogen oxidation reaction activity was evaluated using rotating disk electrodes (“RDEs”). The RDEs were prepared by mixing each of the electrode catalysts of Synthesis Examples 1 to 4, Comparative Synthesis Examples 1 and 2, and a commercially available PtRu/C catalyst manufactured by Tanka Kikinzoku Kogyo K.K. (TKK) (the amount of alloy particles of Pt and Ru supported on a carbonaceous support is 53.4 wt % based on 100 wt % of the electrode catalyst, an atomic ratio of Pt to Ru is 1:1.5) with a NAFION solution (NAFION perfluorinated ion-exchange resin, 5 wt % solution in a mixture of lower aliphatic alcohols and water, obtained from Aldrich) and homogenizing each catalyst therein to prepare a catalyst slurry and coating the catalyst slurry on a glassy carbon to form a thin-film electrode.

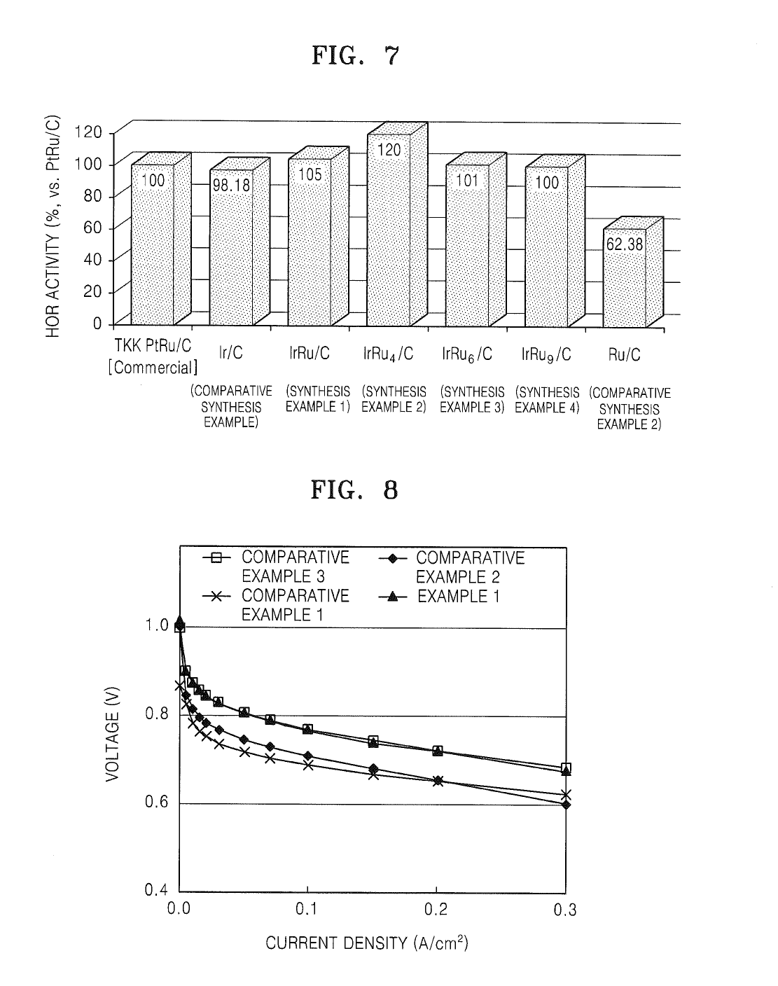

Electrochemical analysis was performed using a three-electrode system. In this regard, a hydrogen-saturated aqueous solution (0.1 molar (M) H₃PO₄) was used as an electrolyte, and a Pt foil and an Ag/AgCl electrode were used as a counter electrode and a reference electrode, respectively. All electrochemical experiments were performed at room temperature. The measurement results are illustrated in FIG. 7.

Referring to FIG. 7, it is confirmed that half cells including the electrode catalysts of Synthesis Examples 1 to 4 have higher HOR performance than half cells including the electrode catalysts of Comparative Synthesis Examples 1 and 2 and have a HOR performance that is the same as or higher HOR performance than a half cell including the PtRu/C catalyst.

### Example 1

An anode of a PEMFC was prepared as follows. 0.03 g of polyvinylidene fluoride (“PVDF”) per 1 g of the electrode catalyst (IrRu₄/C catalyst) of Synthesis Example 2 was mixed with N-methyl-2-pyrrolidone, as a solvent, in an appropriate amount to prepare an anode-forming slurry. The anode-forming slurry was coated on a microporous layer-coated carbon paper by using a bar coater, and the coated carbon paper was then dried by gradually raising the temperature from room temperature to 150° C. to obtain an anode. A loading amount of the electrode catalyst of Synthesis Example 2 in the anode was 1 milligram PdIr per square centimeter (mg_{RuIr}/cm²).

A cathode was prepared using the same method as that used to prepare the anode, except that a carbon-supported PtCo catalyst (Tanaka Precious Metals, Pt: 45 wt %, Co: 5 wt %) was used instead of the electrode catalyst of Synthesis Example 2. A loading amount of the carbon-supported PtCo catalyst in the cathode was 1.5 mg_{Pt}/cm².

Then, 85% phosphoric acid-doped poly(2,5-benzimidazole) as an electrolyte membrane was disposed between the anode and the cathode, thereby completing the manufacture of a fuel cell.

### Comparative Example 1

A fuel cell was manufactured in the same manner as in Example 1, except that the electrode catalyst (Ir/C catalyst) of Comparative Synthesis Example 1 was used instead of the electrode catalyst of Synthesis Example 2.

### Comparative Example 2

A fuel cell was manufactured in the same manner as in Example 1, except that the electrode catalyst (Ru/C catalyst) of Comparative Synthesis Example 2 was used instead of the electrode catalyst of Synthesis Example 2.

### Comparative Example 3

A fuel cell was manufactured in the same manner as in Example 1, except that a PtRu/C catalyst manufactured by TKK (an amount of alloy particles of Pt and Ru supported on a carbonaceous support was 53.4 wt % based on 100 wt % of the electrode catalyst, an atomic ratio of Pt to Ru was 1:1.5) was used instead of the electrode catalyst of Synthesis Example 2.

### Evaluation Example 5

### Unit Cell Performance Evaluation

Performance of the fuel cells manufactured according to Example 1 and Comparative Examples 1 to 3 were evaluated using non-humidified air at a cathode and non-humidified hydrogen at an anode at 150° C., and the results are illustrated in FIG. 8.

Referring to FIG. 8, it was confirmed that an open circuit voltage (“OCV”) of the fuel cell of Example 1 was higher than that of each of the fuel cells of Comparative Examples 1 to 3. In this regard, the open circuit voltage (“OCV”) is related to an oxygen reduction reaction onset potential of a catalyst, and thus it was confirmed that the performance of the fuel cell of Example 1 was higher than the performance of the fuel cells of Comparative Examples 1 to 2.

As described above, according to the disclosed embodiments, an electrode catalyst for a fuel cell has improved hydrogen oxidation activity, and thus a fuel cell having improved performance may be manufactured at reduced cost.

It shall be understood that the exemplary embodiment described herein shall be considered in a descriptive sense only and not for purposes of limitation. Descriptions of features, advantages, or aspects within each embodiment shall be considered as available for other similar features, advantages, or aspects in other embodiments.

1. An electrode catalyst for a fuel cell comprising
alloy particles comprising an alloy of a Group 8 metal and a Group 9 metal.

2. The electrode catalyst of claim 1, wherein the Group 8 metal comprises at least one of iron (Fe), ruthenium (Ru), or osmium (Os).

3. The electrode catalyst of claim 1, wherein the Group 9 metal comprises at least one of cobalt (Co), rhodium (Rh), or iridium (Ir).

4. The electrode catalyst of claim 1, wherein an amount of the Group 8 metal is in a range of about 8 atomic percent to about 92 atomic percent, based on 100 atomic percent of the alloy particles.

5. The electrode catalyst of claim 1, wherein an amount of the Group 8 metal is in a range of about 20 atomic percent to about 90 atomic percent, based on 100 atomic percent of the alloy particles.

6. The electrode catalyst of claim 1, wherein an amount of the Group 9 metal is in a range of about 8 atomic percent to about 90 atomic percent, based on 100 atomic percent of the alloy particles.

7. The electrode catalyst of claim 1, wherein the alloy particles have a core-shell structure;
i) the core comprises the Group 8 metal, but does not comprise the Group 9 metal; and the shell comprises the alloy of the Group 8 metal and the Group 9 metal; or
ii) the core comprises the alloy of the Group 8 metal and the Group 9 metal; and the shell comprises the Group 9 metal, but does not comprise the Group 8 metal.

8. The electrode catalyst of claim 1, wherein the alloy particles have a core-interlayer-shell structure in which the interlayer is between the core and the shell;
the core comprises the Group 8 metal, but does not comprise the Group 9 metal;
the interlayer comprises the alloy of the Group 8 metal and the Group 9 metal; and
the shell comprises the Group 9 metal, but does not comprise the Group 8 metal.

9. The electrode catalyst of claim 1, wherein the Group 8 metal is ruthenium and the Group 9 metal is iridium.

10. The electrode catalyst of claim 1, wherein the alloy particles consist of an alloy of the Group 8 metal and the Group 9 metal.

11. The electrode catalyst of claim 1, wherein the alloy particles further comprise at least one of nickel (Ni), palladium (Pd), platinum (Pt), cobalt (Co), iron (Fe), copper (Cu), tungsten (W), vanadium (V), niobium (Nb), molybdenum (Mo), or hafnium (Hf).

12. The electrode catalyst of claim 1, further comprising a carbonaceous support, wherein the alloy particles are disposed on the carbonaceous support.

13. An electrode catalyst comprising
a carbonaceous support; and
alloy particles represented by Formula 1 disposed on the carbonaceous support
IrₓRu_{y} Formula 1
wherein x and y are each independently about 1 to about 10.

14. A method of preparing an electrode catalyst for a fuel cell, the method comprising:
providing a mixture comprising a Group 8 metal precursor and a Group 9 metal precursor; and
reducing the Group 8 metal precursor and the Group 9 metal precursor in the mixture to prepare the electrode catalyst for a fuel cell, wherein the electrode catalyst comprises alloy particles comprising an alloy of a Group 8 metal and a Group 9 metal.

15. The method of claim 14, wherein the mixture further comprises a carbonaceous support, and the electrode catalyst further comprises the alloy particles disposed on the carbonaceous support.

16. The method of claim 14, wherein the mixture further comprises at least one of a polyol solvent or a monol solvent.

17. A membrane electrode assembly for a fuel cell, comprising:
a cathode;
an anode facing the cathode; and
an electrolyte membrane interposed between the cathode and the anode,
wherein at least one of the cathode and the anode comprises the electrode catalyst according to claim 1.

18. The membrane electrode assembly of claim 17, wherein the anode comprises the electrode catalyst.

19. A fuel cell comprising the membrane electrode assembly of claim 17.

20. The fuel cell of claim 19, wherein the anode comprises the electrode catalyst.
